(19) United States
(12) Patent Application Publication
(10) Pub. No.: US 2019/0283164 A1
(43) Pub. Date: Sep. 19, 2019

(54) SOLDERING JIG

(71) Applicant: ASIA VITAL COMPONENTS CO., LTD., New Taipei City (TW)

(72) Inventor: Meng Shen, New Taipei City (TW)

(21) Appl. No.: 15/925,706

(22) Filed: Mar. 19, 2018

(51) Int. Cl. B23K 3/08

(52) U.S. Cl. CPC B23K 3/087

(57) ABSTRACT

The present invention relates to a soldering jig. The soldering jig comprises a substrate having a soldering area and at least one positioning area in which a positioning part is disposed in the positioning area. A workpiece is placed on the substrate and positioned through the positioning part. By means of a heating method, an isolating film is moved from the workpiece. A piece of solder is placed in the soldering area of the substrate and melting such that the workpiece is soldered to the soldering area through the piece of solder.

### BACKGROUND OF THE INVENTION

### Field of the Invention

The present invention relates to a soldering jig and in particular to a soldering jig which is applied to a magnet wire.

### Description of Prior Art

The soldering technique, commonly applied to various fields, is used to fix a workpiece to another object through solder. When soldering a magnet wire manually, the worker uses one hand to hold a soldering iron and the other hand to hold a solder wire or to fix the workpiece.

However, the traditional manual soldering suffers the following disadvantages:

(1) Higher soldering skill is required for a soldering technician. Professional training is necessary to obtain better performance.

(2) Manual soldering is prone to suffer the rupture of a magnet wire.

(3) Failure (e.g., an open circuit, a poor contact, excessive resistance) occurs easily at soldering points.

(4) The soldering results of the soldering points are not consistent. For example, excessive height of the soldering point causes interference with other parts.

(5) Low efficiency.

How to solve the problems and disadvantages of the above prior art is the target which the industry and the inventor strive to reach.

### SUMMARY OF THE INVENTION

Thus, to effectively overcome the above problems, it is one objective of the present invention to provide a soldering jig, which can relax the requirements for the worker's skills.

It is another objective of the present invention to provide a soldering jig, which can prevent the rupture of a magnet wire.

It is yet another objective of the present invention to provide a soldering jig, which can prevent a poor contact at soldering points.

It is yet another objective of the present invention to provide a soldering jig, which can obtain consistent specifications for the soldering points to facilitate the subsequent process.

It is yet another objective of the present invention to provide a soldering jig, which can enhance the whole efficiency.

To achieve the above objectives, the present invention provides a soldering jig comprising a substrate and at least one positioning part. The substrate has a soldering area and at least one positioning area disposed outside of the soldering area. The at least one positioning part is disposed in the positioning area to position a workpiece; the workpiece is placed in the soldering area and the positioning area; the workpiece has a soldering portion corresponding to the soldering area and at least one non-soldering portion corresponding to the positioning area.

In one embodiment, a circular wall is disposed at the outer edge of the substrate and the positioning area has a first protruding recess which protrudes out of the circular wall.

In one embodiment, the positioning area has a second protruding recess which protrudes out of the circular wall; the first protruding recess and the second protruding recess lie on a straight line.

In one embodiment, the positioning part is a twin adhesive or an adhesive.

In one embodiment, the workpiece is a magnet wire.

### BRIEF DESCRIPTION OF DRAWING

FIG. 1A is a perspective view of the soldering jig according to the first embodiment of the present invention;

FIG. 1B is a cross-sectional view of the soldering jig according to the first embodiment of the present invention;

FIG. 1C is an operational view of the soldering jig according to the first embodiment of the present invention;

FIG. 1D is another operational view of the soldering jig according to the first embodiment of the present invention;

FIG. 2A is a perspective view of the soldering jig according to the second embodiment of the present invention;

FIG. 2B is an operational view of the soldering jig according to the second embodiment of the present invention;

FIG. 3A is a perspective view of the soldering jig according to the third embodiment of the present invention; and

FIG. 3B is an operational view of the soldering jig according to the third embodiment of the present invention.

### DETAILED DESCRIPTION OF THE INVENTION

The above objectives, the structural and functional characteristics of the present invention will be described according to the preferred embodiments with the accompanying figures.

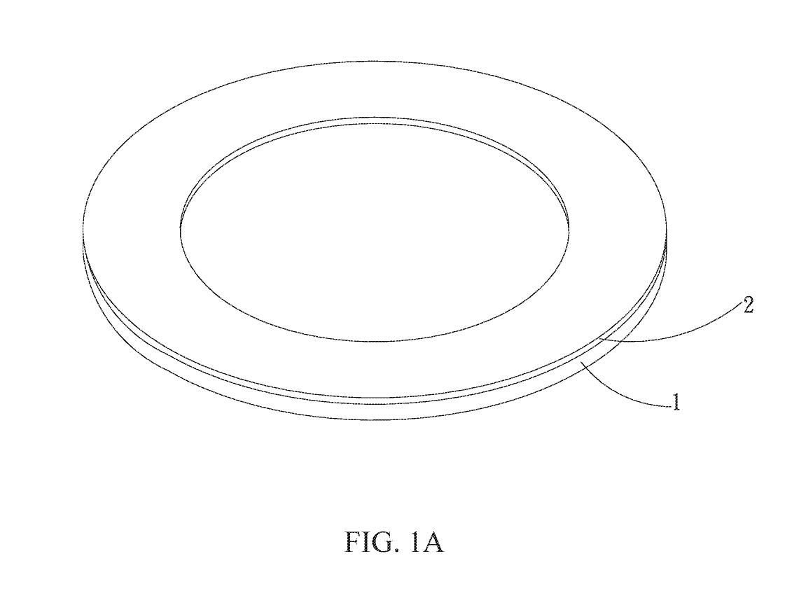

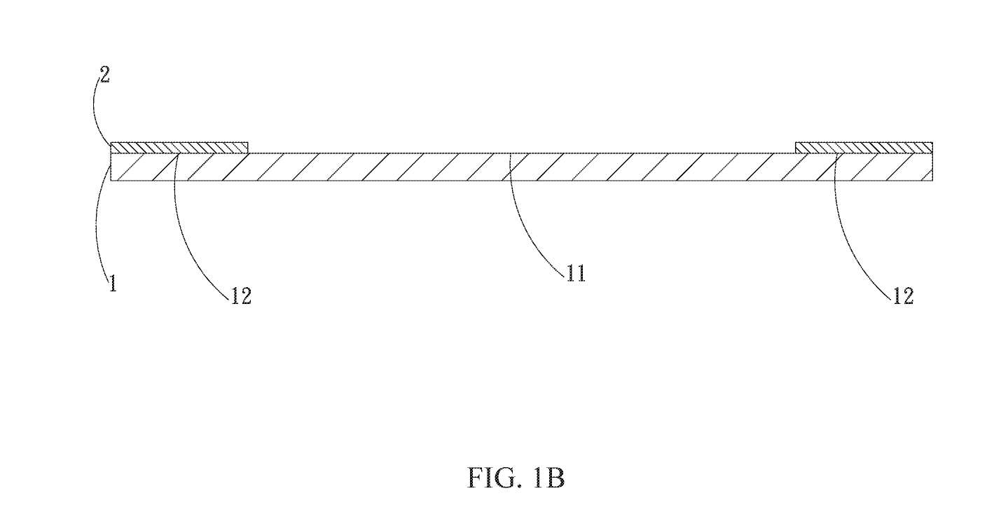

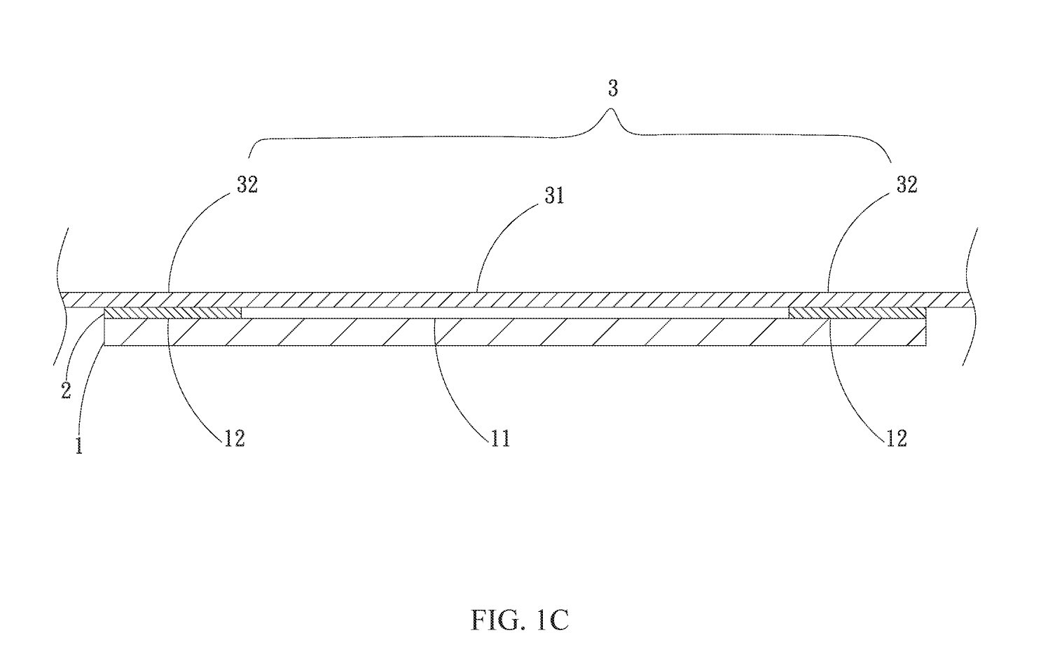

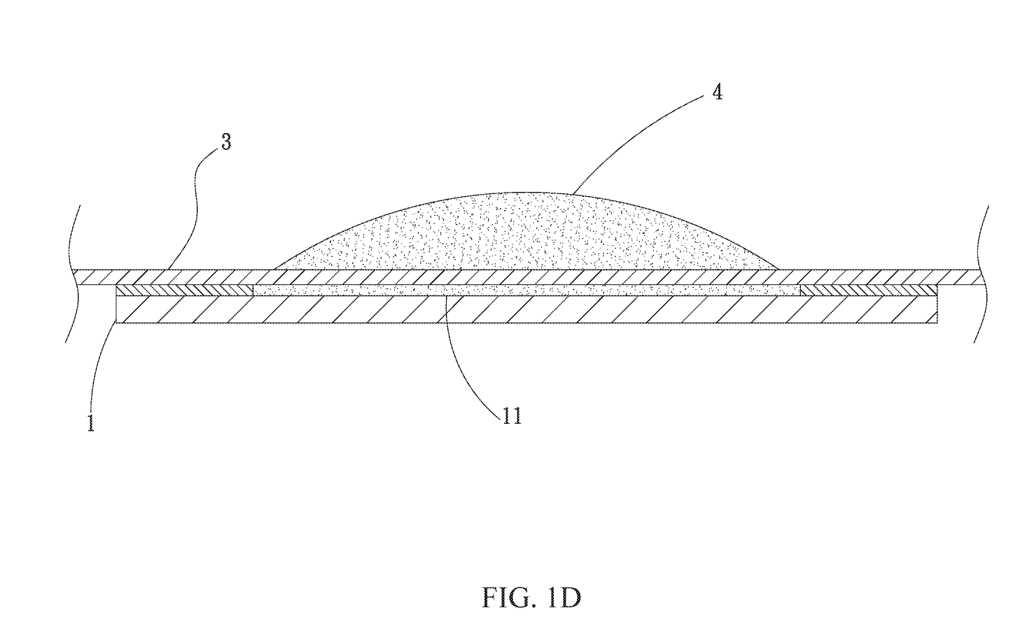

Please refer to FIGS. 1A, 1B, 1C, and 1D, which are the perspective view, the cross-sectional view, the operational view, and the another operational view of the soldering jig according to the first embodiment of the present invention, respectively. The present invention comprises a substrate 1 and at least one positioning part 2. The substrate 1 has a soldering area 11 and at least one positioning area 12 disposed at the outer edge of the soldering area 11. The positioning part 2 is disposed in the positioning area 12. The positioning part 2 can be a twin adhesive or an adhesive. The substrate 1 may have any shape like a circle, a regular polygon, or an irregular polygon.

The workpiece 3, not limited to a magnet wire, has a soldering portion 31 and at least one non-soldering portion 32. The soldering portion 31 is disposed corresponding to the soldering area 11 and the non-soldering portion 32 is disposed corresponding to the positioning area 12.

Referring to FIG. 1C, in operation, the workpiece 3 is placed on the substrate 1. The soldering portion 31 is aligned with the soldering area 11 and the non-soldering portion 32 is aligned with the positioning area 12. The positioning part 2 on the positioning area 12 will stick to the non-soldering portion 32 such that the workpiece 3 cannot be moved easily to be secured.

Please refer to FIG. 1D. When the soldering process is performed, the isolating film on the workpiece 3 is removed using a heating method, for example, but not limited to, the laser heating, the butt welding, or other equivalent methods and then a piece of solder 4 is placed in the soldering area 11 of the substrate 1. Next, the piece of solder 4 is heated and melted using the heating method, for example, but not limited to, the laser heating, the butt welding, or other equivalent methods such that the workpiece 3 is soldered and fixed to the soldering area 11.

The above-mentioned positioning part 2 uses a twin adhesive or an adhesive to fix the workpiece 3 in an adhesive way. Also, the positioning part 2 can be a magnetic object such as a magnet or an electromagnet to fix the workpiece 3 in a magnetic-fixing way.

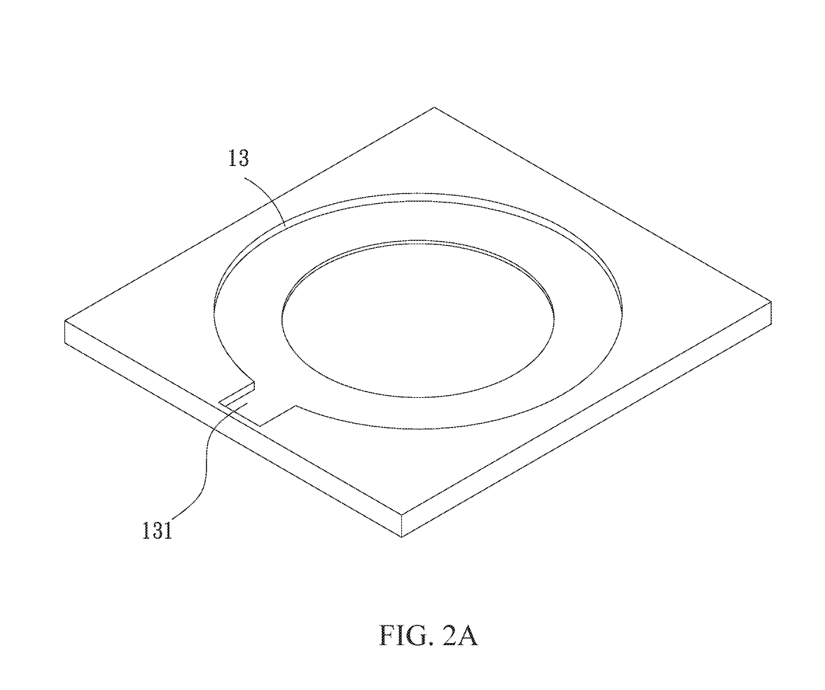

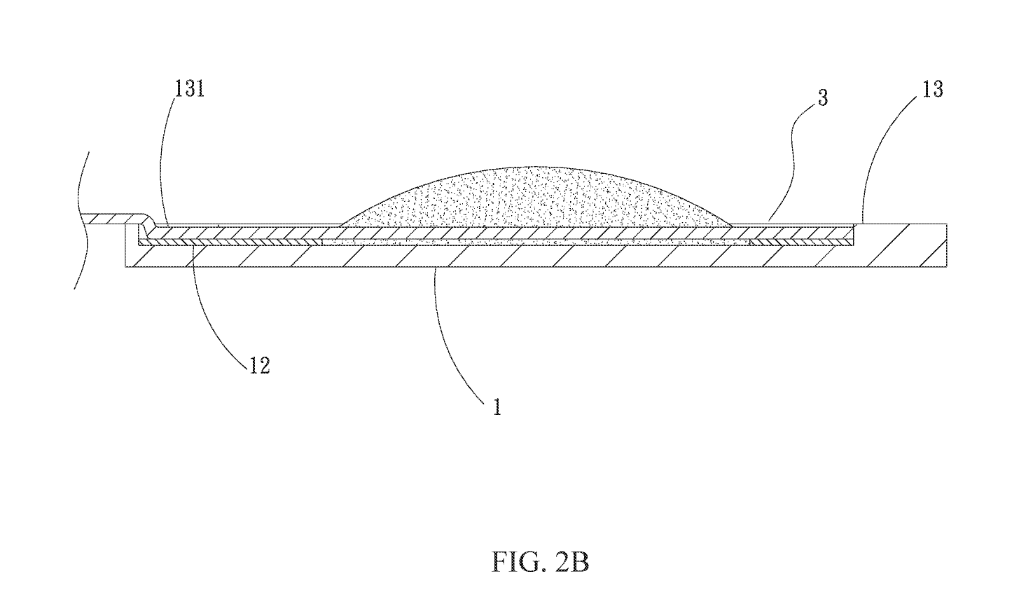

Please refer to FIGS. 2A and 2B, which are the perspective view and the operational view of the soldering jig according to the second embodiment of the present invention, respectively. Some structures in the second embodiment are the same as those in the first embodiment and will not be described here again. The main difference between the first and the second embodiments is that, in the second embodiment, a circular wall 13 is disposed at the outer edge of the substrate 1. The circular wall 13 has a first protruding recess 131 which is disposed corresponding to the positioning area 12 and protrudes out of the circular wall 13. The length and the width of the first protruding recess 131 may change based on the specification of the workpiece 3 like the wire diameter and based on the use. The first protruding recess 131 places a constraint on the workpiece 3 horizontally.

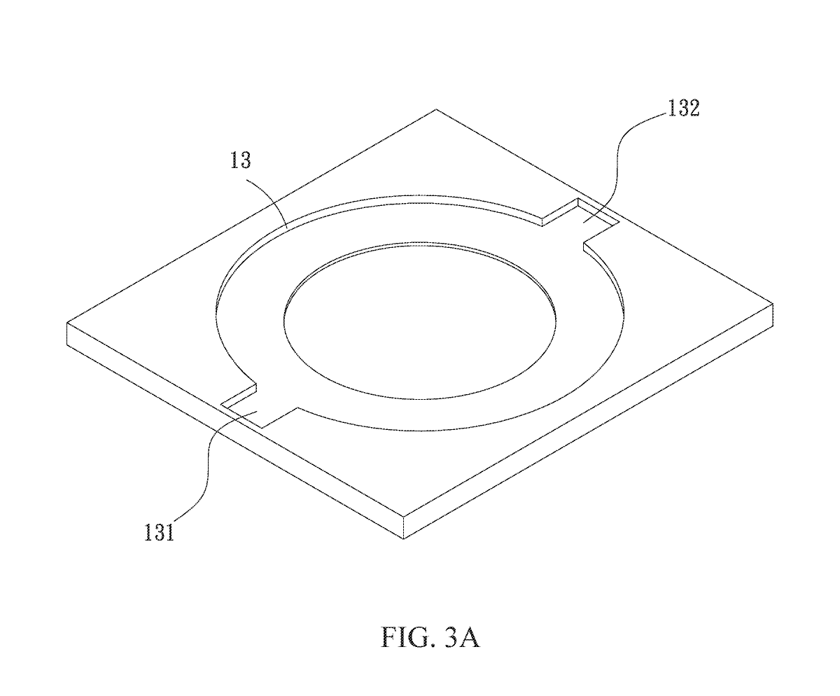

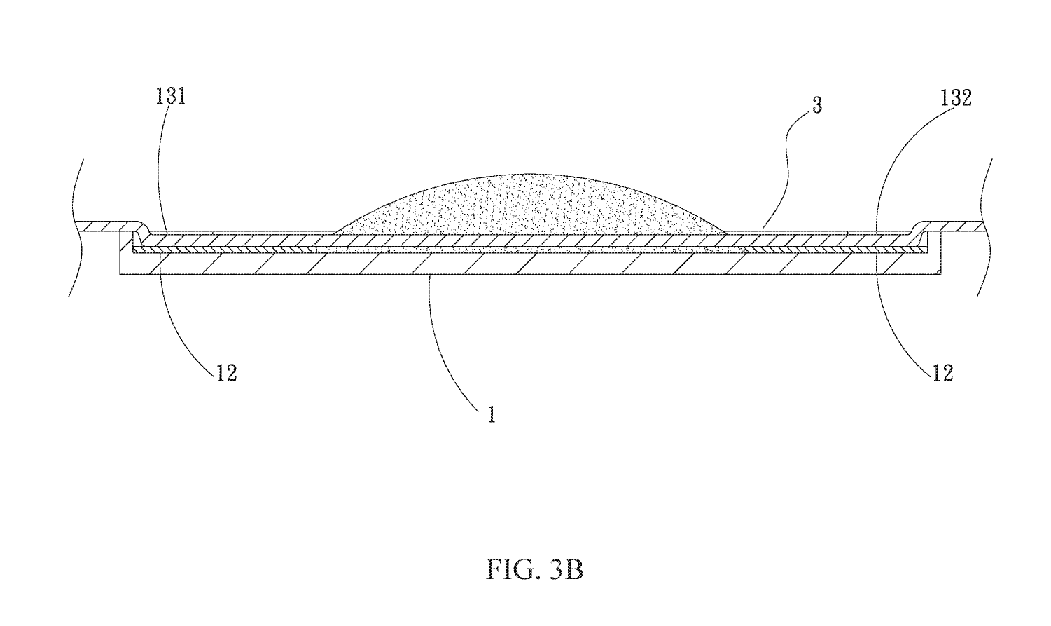

Please refer to FIGS. 3A and 3B, which are the perspective view and the operational view of the soldering jig according to the third embodiment of the present invention, respectively. Some structures in the third embodiment are the same as those in the first embodiment and will not be described here again. The main difference between the first and the third embodiments is that, in the third embodiment, a circular wall 13 is disposed at the outer edge of the substrate 1; the circular wall 13 has a first protruding recess 131 and a second protruding recess 132. The first protruding recess 131 and the second protruding recess 132 are disposed corresponding to the positioning area 12, both protruding out of the circular wall 13, and lying on a straight line. The lengths and the widths of the first and second protruding recesses 131, 132 may change based on the specification of the workpiece 3 like the wire diameter and based on the use. The first and second protruding recesses 131, 132 place a constraint on the workpiece 3 horizontally and ensure that the workpiece 3 remains straight.

The present invention has the following advantages by means of the above-mentioned structure.

(1) The skill requirements are reduced. Any ordinary worker who can operate the automatic heating machine or the soldering machine step by step is qualified.

(2) The rupture of a magnet wire can be prevented.

(3) The quality issues regarding soldering points are decreased.

(4) The soldering results of the soldering points are consistent, which effectively controls the heights of the solder points and prevents interference with other parts.

(5) The efficiency is enhanced.

The detailed description of the present invention is given above. The embodiments described above are only preferred ones of the present invention. All the equivalent modifications and variations using the methods, shapes, structures, and apparatus in the specification and figures of the present invention should be embraced by the claimed scope of the present invention.

What is claimed is:

1. A soldering jig, comprising:
a substrate having a soldering area and at least one positioning area disposed outside of the soldering area; and
at least one positioning part disposed in the positioning area to position a workpiece, wherein the workpiece is placed in the soldering area and the positioning area, wherein the workpiece has a soldering portion corresponding to the soldering area and at least one non-soldering portion corresponding to the positioning area.

2. The soldering jig according to claim 1, wherein a circular wall is disposed at the outer edge of the substrate, wherein the positioning area has a first protruding recess which protrudes out of the circular wall.

3. The soldering jig according to claim 2, wherein the positioning area has a second protruding recess which protrudes out of the circular wall, wherein the first protruding recess and the second protruding recess lie on a straight line.

4. The soldering jig according to claim 1, wherein the positioning part is a twin adhesive or an adhesive.

5. The soldering jig according to claim 1, wherein the workpiece is a magnet wire.
